(19) United States
(12) Patent Application Publication
(10) Pub. No.: US 2025/0274859 A1
(43) Pub. Date: Aug. 28, 2025

(54) REPORTING OF RELAXATION STATUS OF SIGNAL MEASUREMENT

(71) Applicant: Nokia Technologies Oy, Espoo (FI)

(72) Inventors: Lars DALSGAARD, Oulu (FI); Lei DU, Beijing (CN); Jorma Johannes KAIKKONEN, Oulu (FI); Jussi-Pekka KOSKINEN, Oulu (FI); Samuli Heikki TURTINEN, Oulu (FI)

(21) Appl. No.: 18/862,443

(22) PCT Filed: May 13, 2022
(86) PCT No.: PCT/CN2022/092864

§ 371 Date: Nov. 1, 2024

(51) Int. Cl. H04W 52/02; H04W 24/10; H04W 76/28

(52) U.S. Cl. CPC H04W 52/0225; H04W 24/10; H04W 52/0216; H04W 76/28

(57) ABSTRACT

Embodiments of the present disclosure relate to reporting of relaxation status of signal measurement. A first device performs a first evaluation to determine whether a relaxation criterion of signal measurement is met and performs a second evaluation to determine whether a transition between DRX and non-DRX occurs. Then the first device determines, based on at least one of the first evaluation or the second evaluation, whether a report regarding a change of a relaxation status of the signal measurement is initiated to be transmitted to a second device. In this way, a report for a relaxation status of signal measurement may be sent properly and unnecessary signaling overhead and additional power consumption may be avoided.

### FIELD

Embodiments of the present disclosure generally relate to the field of telecommunication and in particular, to a reporting of a relaxation status of signal measurement.

### BACKGROUND

The third generation partnership project (3GPP) is working on a work item (WI) related to user equipment (UE) power saving by relaxation of signal measurement for radio link monitoring (RLM) and/or beam failure detection (BFD). Generally, the relaxation of signal measurement for RLM and/or BFD is allowed only when discontinuous reception (DRX) is used. If a reporting of a relaxation status is configured, UE is supposed to indicate a change of the relaxation status once the UE is transitioning between “DRX is used” and “DRX is not used”. However, such reporting may be unnecessary if evaluation outcome of a relaxation criterion remains unchanged. In addition, to send the reporting when DRX is used, the UE needs to wake up from DRX. This may cause additional power consumption. Thus, a reporting of a relaxation status of signal measurement needs to be further developed.

### SUMMARY

In general, example embodiments of the present disclosure provide a solution for a reporting of a relaxation status of signal measurement.

In a first aspect, there is provided a first device. The first device comprises: at least one processor; and at least one memory including computer program codes; the at least one memory and the computer program codes are configured to, with the at least one processor, cause the first device to: perform a first evaluation to determine whether a relaxation criterion of signal measurement is met; perform a second evaluation to determine whether a transition between discontinuous reception and non-discontinuous reception occurs; and determine, based on at least one of the first evaluation or the second evaluation, whether a report regarding a change of a relaxation status of the signal measurement is initiated to be transmitted to a second device.

In a second aspect, there is provided a second device. The second device comprises: at least one processor; and at least one memory including computer program codes; the at least one memory and the computer program codes are configured to, with the at least one processor, cause the second device to: transmit, to a first device, a configuration indicating that a report regarding a change of a relaxation status of signal measurement is unallowed to be transmitted during discontinuous reception; and receive, from the first device, the report triggered based on a relaxation criterion of the signal measurement.

In a third aspect, there is provided a method of communication. The method comprises: performing, at a first device, a first evaluation to determine whether a relaxation criterion of signal measurement is met; performing a second evaluation to determine whether a transition between discontinuous reception and non-discontinuous reception occurs; and determining, based on at least one of the first evaluation or the second evaluation, whether a report regarding a change of a relaxation status of the signal measurement is initiated to be transmitted to a second device.

In a fourth aspect, there is provided a method of communication. The method comprises: transmitting, at a second device and to a first device, a configuration indicating that a report regarding a change of a relaxation status of signal measurement is unallowed to be transmitted during discontinuous reception; and receiving, from the first device, the report triggered based on a relaxation criterion of the signal measurement.

In a fifth aspect, there is provided a non-transitory computer readable medium. The non-transitory computer readable medium comprises program instructions for causing an apparatus to perform the method according to the third or fourth aspects.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication network in which example embodiments of the present disclosure may be implemented;

FIG. 2 illustrates a diagram illustrating an example reporting regarding a change of a relaxation status of signal measurement according to a conventional solution;

FIG. 3 illustrates a diagram illustrating a process for reporting a change of a relaxation status of signal measurement according to some embodiments of the present disclosure;

FIG. 4A illustrates a diagram illustrating an example reporting regarding a change of a relaxation status of signal measurement according to some embodiments of the present disclosure;

FIG. 4B illustrates a diagram illustrating another example reporting regarding a change of a relaxation status of signal measurement according to some embodiments of the present disclosure;

FIG. 5 illustrates a flowchart of an example method of communication implemented at a first device according to example embodiments of the present disclosure;

FIG. 6 illustrates a flowchart of an example method of communication implemented at a second device according to example embodiments of the present disclosure;

FIG. 7 illustrates a simplified block diagram of an apparatus that is suitable for implementing example embodiments of the present disclosure; and

FIG. 8 illustrates a block diagram of an example computer readable medium in accordance with example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory (ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), 5.5G, 5G-Advanced networks, or the future sixth generation (6G) communication protocols and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, UE, a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

In the context of the present disclosure, the expression “DRX is used” may refer to cases that DRX configuration is configured and UE is in DRX (for example, does not monitor a physical downlink control channel (PDCCH) from downlink (DL) or is not in active time). The expression “DRX is used” may be interchangeably used with “DRX is in use” or “during DRX”.

The expression “DRX is not used” may refer to cases that DRX configuration is configured but UE is not in DRX (for example, the UE monitors PDCCH from DL and/or is in active time) or may refer to case that DRX configuration is not configured for the UE and obviously the UE does not apply DRX. The expression “DRX is not used” may be interchangeably used with “DRX is not in use” or “no DRX” or “during non-DRX”.

Currently, it has been agreed that UE is allowed to relax signal measurement for RLM and/or BFD if serving cell quality and/or low mobility criteria are fulfilled. It has been further agreed that the relaxation is allowed only for DRX cycle≤80 ms and when DRX is used, as otherwise UE is expected to actively monitor channel e.g. for data transmission and hence no power can be saved by the relaxation of signal measurement. In addition, it has been agreed that if a reporting of relaxation status is configured, UE shall trigger reporting of the relaxation status in case of a change of the relaxation status.

In this event, UE is supposed to indicate a change of the relaxation status once the UE is transitioning between “DRX is used” and “DRX is not used”. Such reporting may be unnecessary if evaluation outcome of a relaxation criterion remains unchanged. In addition, to send the reporting when DRX is used, the UE needs to wake up from DRX. This may cause additional power consumption.

In view of this, embodiments of the present disclosure provide a solution of reporting a relaxation status of signal measurement so as to overcome the above and other potential issues. In the solution, a first device performs a first evaluation to determine whether a relaxation criterion of signal measurement is met, and performs a second evaluation to determine whether a transition between DRX and non-DRX occurs. Then the first device determines, based on at least one of the first or second evaluation, whether a report regarding a change of a relaxation status of the signal measurement is initiated to be transmitted to a second device.

In this way, a report for a relaxation status of signal measurement may be sent properly and unnecessary signaling overhead and additional power consumption may be avoided.

Principles and implementations of the present disclosure will be described in detail below with reference to the figures. However, those skilled in the art would readily appreciate that the detailed description given herein with respect to these figures is for explanatory purpose as the present disclosure extends beyond theses limited embodiments.

### Example of Communication Network

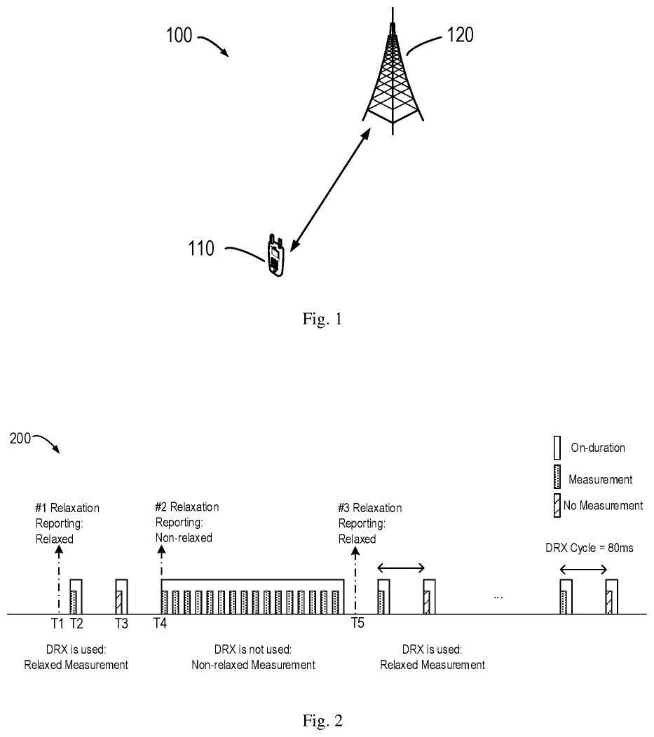

FIG. 1 illustrates an example communication network 100 in which embodiments of the present disclosure can be implemented. As shown in FIG. 1, the network 100 includes a first device 110 and a second device 120. The second device 120 may provide one or more serving cells serving one or more devices. In this example, the first device 110 is located in a serving cell (not shown) of the second device 120 and is served by the second device 120.

Merely for illustration purpose and without suggesting any limitations as to the scope of the present disclosure, some embodiments will be described in the context where the first device 110 is a terminal device and the second device 120 is a network device. It is to be understood that, in other embodiments, the first device 110 may be a network device and the second device 120 may be a terminal device. In other words, the present disclosure can be applied to both uplink and downlink transmissions.

It is to be understood that the number and type of first and second devices as shown in FIG. 1 are only for the purpose of illustration without suggesting any limitations. The network 100 may include any suitable number and type of first and second devices adapted for implementing embodiments of the present disclosure.

As shown in FIG. 1, the first device 110 and the second device 120 may communicate with each other via a channel such as a wireless communication channel. The communications in the network 100 may conform to any suitable standards including, but not limited to, LTE, LTE-evolution, LTE-advanced (LTE-A), WCDMA, code division multiple access (CDMA) and global system for mobile communications (GSM) and the like. Furthermore, the communications may be performed according to any generation communication protocols either currently known or to be developed in the future. Examples of the communication protocols include, but not limited to, 1G, 2G, 2.5G, 2.75G, 3G, 4G, 4.5G, 5G, 5.5G, 5G-Advanced networks, or the future 6G communication protocols.

In some example embodiments, the first device 110 may receive, from the second device 120, a configuration for RLM measurement. Based on the configuration for RLM measurement, the first device 110 may receive, from the second device 120, a set of RLM-reference signals (RLM-RSs) on a set of configured RLM-RS resources and perform measurements on the set of RLM-RSs. In this way, the first device 110 may perform RLM measurement. In some example embodiments, the RLM measurement may be relaxed, for example, the RLM measurement may be performed on only a portion of the configured RLM-RS resources.

In some example embodiments, each of the first device 110 and the second device 120 may have a plurality of beams. A channel or sub-channel may be formed between a beam of the first device 110 and a beam of the second device 120. In some example embodiments, the first device 110 may receive, from the second device 120, a configuration for BFD measurement. Based on the configuration for BFD measurement, the first device 110 may receive, from the second device 120, a set of BFD-RSs on a set of configured BFD-RS resources and perform measurements on the set of BFD-RSs. In this way, the first device 110 may perform BFD measurement. In some example embodiments, the BFD measurement may be relaxed, for example, the BFD measurement may be performed on only a portion of the configured BFD-RS resources.

In some example embodiments for RLM and/or BFD measurement relaxation, the first device 110 may receive, from the second device 120, a configuration for a relaxation criterion for low mobility and/or good serving cell quality. The first device 110 may perform evaluation of the relaxation criterion, and perform RLM and/or BFD relaxation or relaxed RLM/BFD measurements when the relaxation criterion is met and perform RLM and/or BFD non-relaxation or non-relaxed/legacy RLM/BFD measurement when the relaxation criterion is not met.

In some example embodiments, the first device 110 may receive, from the second device 120, a configuration indicating a reporting of a change of a relaxation status, for example, a change from non-relaxation to relaxation or a change from relaxation to non-relaxation. In this case, the first device 110 may trigger reporting of its RLM and/or BFD relaxation status through UE assistance information if the first device 110 changes its respective RLM and/or BFD relaxation status while meeting UE minimum requirements.

In some example embodiments, the first device 110 needs to monitor a downlink control channel such as a PDCCH from the second device 120. The PDCCH monitoring consumes a significant amount of power at the first device 110. Thus, the first device 110 may be configured to perform DRX.

As known, UE is allowed to relax RLM and/or BFD measurements only when short DRX cycle is used. If the relaxation reporting (i.e. the reporting of the relaxation status) is configured, the UE is supposed to indicate a change of a relaxation status once the UE is transitioning between “DRX is used (i.e. DRX in use)” and “DRX is not used (i.e. no DRX)”. FIG. 2 illustrates a diagram 200 illustrating an example reporting regarding a change of a relaxation status of signal measurement according to a conventional solution. It is assumed that a DRX cycle is 80 ms.

As shown in FIG. 2, at a timing T1, UE detects that a relaxation criterion is met and starts relaxation. Hence, the UE sends the #1 relaxation reporting indicating the start of RLM/BFD relaxation as DRX is used. Then, RLM/BFD measurements may be relaxed during DRX. For example, at a timing T2, an on-duration for DRX starts (i.e. DRX is used) and signal measurement may be performed. At a timing T3, an on-duration for DRX starts again, but signal measurement may be skipped for relaxation.

At a timing T4, an inactivity timer for DRX (e.g., a DRX-inactivity timer) may start due to e.g. data transmission. Then DRX is not used and the UE sends #2 relaxation reporting indicating the reverting to non-relaxed RLM/BFD measurements. When the inactivity timer expires, if the relaxation criterion is still met, the UE could start RLM/BFD relaxation again. As shown in FIG. 2, at timing T5, the UE may again send the #3 relaxation reporting indicating the start of RLM/BFD relaxation. While the UE transitions between DRX and non-DRX, the relaxation status of signal measurement may be changed between relaxed and non-relaxed RLM/BFD measurement, but the UE keeps evaluating the downlink radio link quality fulfilling the minimum requirements and keeps evaluating the relaxation criterion. That is, when the UE performs non-relaxed RLM/BFD measurements, the UE shall be able to evaluate the downlink radio link quality within a legacy evaluation period. When the UE performs relaxed RLM/BFD measurements, the UE shall be able to evaluate the downlink radio link quality within a relaxed or longer evaluation period. And during the transition period between DRX and non-DRX, the minimum value of the relaxed and non-relaxed evaluation periods shall apply. The evaluation of the relaxation criterion may be also based on the RLM/BFD measurement results fulfilling the minimum requirements.

In the example of FIG. 2, #2 and #3 relaxation reporting are triggered not because of the relaxation criterion is met or not, but they are triggered due to the transition between “DRX is used” and “DRX is not used or no DRX”. If the evaluation outcome of relaxation criterion remains unchanged, such relaxation reporting is unnecessary. As the relaxation is allowed only for short DRX cycle below 80 ms, the frequent transition between “DRX in use” and “no DRX” would result in frequent relaxation reporting in the beginning and at the end of active time. This will unnecessarily cause signaling overhead as well as additional power consumption.

In addition, in order to send the relaxation reporting (e.g., #1 and #3 relaxation reporting) when DRX is used, the UE needs to wake up from DRX which forces the UE to exit from relaxed RLM/BFD measurements. This needs to be avoided or at least minimized as this is at the cost of additional power consumption.

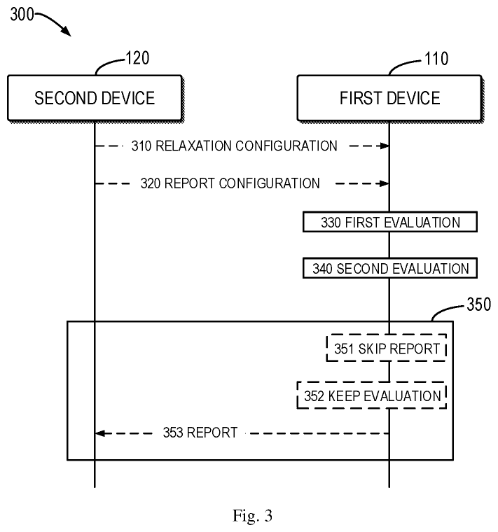

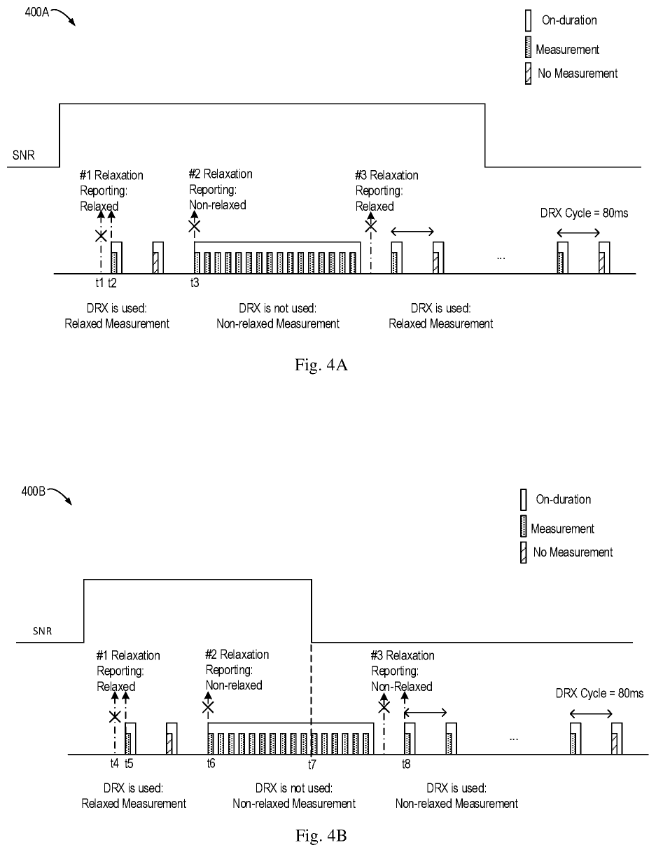

In order to solve the above and other potential issues, embodiments of the present disclosure provide an improved solution for relaxation status reporting. More details will be described below in connection with FIGS. 3 to 4B.

### Example Implementation of Relaxation Reporting

FIG. 3 illustrates a diagram illustrating a process 300 for reporting a change of a relaxation status of signal measurement according to some embodiments of the present disclosure. For convenience, the following description will be made in connection with FIG. 1.

As shown in FIG. 3, the second device 120 may transmit 310, to the first device 110, a configuration for measurement relaxation. In some example embodiments, the configuration for measurement relaxation may comprise at least a relaxation criterion of signal measurement. In some example embodiments, the relaxation criterion may comprise low mobility (for example, mobility is below threshold mobility or the variation of channel measurement is no more than a threshold within a certain time). In some example embodiments, the relaxation criterion may comprise good serving cell quality (for example, serving cell quality is above threshold quality). It is to be understood that the relaxation criterion may comprise any other suitable criteria or combination of criteria. It is also to be understood that the configuration for measurement relaxation may be optional, and the relaxation criterion may be predefined. The present disclosure does not limit this aspect.

The second device 120 may also transmit 320, to the first device 110, a configuration for relaxation status reporting. It is to be understood that the configuration for relaxation status reporting may comprise any suitable information. It is also to be understood that the configuration for relaxation status reporting may be optional, and the relaxation status reporting may be predefined. The present disclosure does not limit this aspect.

Continue to refer to FIG. 3, the first device 110 performs 330 an evaluation (for convenience, also referred to as a first evaluation herein) to determine whether the relaxation criterion of signal measurement is met. In some example embodiments, if radio link quality of the first device 110 is changed to be higher than or equal to threshold radio link quality, the first device 110 may determine the relaxation criterion is met. In some example embodiments, if the first device 110 is determined to be in a low mobility state, the first device 110 may determine the relaxation criterion is met. In some example embodiments, if serving cell quality of the first device 110 is changed to be higher than or equal to threshold serving cell quality, and the first device 110 is determined to be in a low mobility state, the first device 110 may determine the relaxation criterion is met. These are merely examples, and are not intended for limitation. The evaluation of the relaxation criterion may be performed in any other suitable ways.

The first device 110 also performs 340 an evaluation (for convenience, also referred to as a second evaluation herein) to determine whether a transition between DRX and non-DRX occurs. The transition between DRX and non-DRX may comprise a transition from DRX to non-DRX or a transition from non-DRX to DRX. The transition from DRX to non-DRX may refer to a transition from “DRX is used” to “DRX is not used” or a transition from “DRX in use” to “no DRX”. The transition from non-DRX to DRX may refer to a transition from “DRX is not used” to “DRX is used” or a transition from “no DRX” to “DRX in use”.

In some example embodiments, the first device 110 may determine that the first device 110 is in the non-DRX if DRX is not configured (e.g., if DRX parameters is not configured). In some example embodiments, the first device 110 may determine that the first device 110 is in the non-DRX if DRX is configured (e.g., if DRX parameters is configured) and an inactivity timer for DRX (e.g., drx-InactivityTimer) is running. In some example embodiments, the first device 110 may determine that the first device 110 is in the non-DRX if DRX is configured (e.g., if DRX parameters is configured) and a retransmission timer for DRX for downlink (e.g., drx-RetransmissionTimerDL) is running. In some example embodiments, the first device 110 may determine that the first device 110 is in the non-DRX if DRX is configured (e.g., if DRX parameters is configured) and a retransmission timer for DRX for uplink (e.g., drx-RetransmissionTimerUL) is running. In some example embodiments, the first device 110 may determine that the first device 110 is in the non-DRX if DRX is configured (e.g., if DRX parameters is configured) and a contention resolution timer for random access (RA) (e.g., ra-ContentionResolutionTimer) is running. In some example embodiments, the first device 110 may determine that the first device 110 is in the non-DRX if DRX is configured (e.g., if DRX parameters is configured) and a scheduling request (SR) transmitted on a physical uplink control channel (PUCCH) is pending. In some example embodiments, the first device 110 may determine that the first device 110 is in the non-DRX if DRX is configured (e.g., if DRX parameters is configured) and a PDCCH indicating a new transmission addressed to an identity (e.g., cell-radio network temporary identifier (C-RNTI)) of a medium access control (MAC) entity has not been received after successful reception of a random access response (RAR) for a preamble not selected by the MAC entity. Otherwise, the first device 110 may determine that the first device 110 is in DRX or DRX is used. It is to be understood that any other suitable ways are also feasible.

Based on at least one of the first evaluation or the second evaluation, the first device 110 determines 350 whether a report is initiated to be transmitted to the second device 120. That is, the first device 110 may determine whether the report is to be transmitted to the second device 120.

In some example embodiments, if the relaxation status is changed only due to the transition between DRX and non-DRX, the first device 110 may determine 351 that the report is not initiated to be transmitted to the second device 120. For example, the relaxation status may be changed when UE enters DRX from active time, e.g., due to expiry of drx-InactivityTimer or drx-onDurationTimer or reception of DRX Command MAC control element (CE) from the network. As another example, the relaxation status may be changed when UE enters active time from DRX, e.g., due to start of drx-InactivityTimer, SR trigger, RA procedure trigger, etc. In these examples, the first device 110 may determine that the report is not initiated to be transmitted to the second device 120. That is, the report is skipped to be transmitted. In this way, unnecessary signaling overhead on relaxation reporting may be avoided and thus additional power consumption may also be avoided.

In some example embodiments where the report is skipped to be transmitted, the first device 110 may keep 352 evaluating the relaxation criterion (i.e., keep performing the first evaluation). In this way, efficient management of measurement relaxation may be achieved, and thus power consumption may be further reduced.

In some example embodiments, if the relaxation status is changed based on the relaxation criterion, the first device 110 may determine 353 that the report is initiated to be transmitted to the second device 120. In this way, unnecessary signaling overhead on relaxation reporting may be avoided and thus additional power consumption may also be avoided.

In some example embodiments, if the first device 110 starts relaxation when DRX is in use, the first device 110 may delay the transmission of the report until an on-duration for DRX (i.e. drx-OnDurationTimer) starts. In some example embodiments, if the report indicates a change of a relaxation status from relaxed to non-relaxed RLM/BFD measurement, the first device 110 may delay the transmission of the report until an on-duration for DRX starts. Otherwise, the first device 110 may not delay the transmission of the report. In this way, a device may not wake up from DRX to send a relaxation reporting, and will also not exit from relaxed RLM and/or BFD measurements. Thus, additional power consumption will be avoided.

In some example embodiments, if the first device 110 receives, from the second device 120, a configuration indicating that the report is not allowed to be transmitted during DRX, the first device 110 may delay the transmission of the report until an on-duration for DRX starts. In this way, a device will not wake up from DRX to send a relaxation reporting, and will also not exit from relaxed RLM and/or BFD measurements. Thus, additional power consumption will also be avoided. Further, at least network may avoid the flood of UE reports solely aiming at informing the network of entering or leaving relaxed RLM and/or BFD measurements (which may be utterly useless for running the network).

In some example embodiments, if the relaxation criterion triggers the change of the relaxation status, the first device 110 may be allowed to trigger reporting the change of the relaxation status when DRX is in use. In some example embodiments, if the relaxation criterion triggers the change of the relaxation status, and if the report indicates a change of a relaxation status from non-relaxed to relaxed RLM/BFD measurement, the first device 110 may be allowed to trigger reporting the change of the relaxation status when DRX is in use. In this case, the first device 110 may not delay the transmission of the report so as to properly report the change of the relaxation status.

In some example embodiments, the report may comprise a period of time for which the change of the relaxation status of the signal measurement has been performed. For example, the period of time may be represented by the number of DRX cycles. It is to be understood that any other suitable ways are also feasible. In this way, if a relaxation reporting has been suspended by a prohibit timer, the first device 110 may additional report how long the first device 110 has relaxed signal measurements.

In some example embodiments, the report may comprise a cause of the change of the relaxation status of the signal measurement. In some example embodiments, the cause may comprise a change of a low mobility state. In some example embodiments, the cause may comprise a change of serving cell quality. In some example embodiments, the cause may comprise a change of both a low mobility state and serving cell quality. In some example embodiments, the cause may comprise a set of signals or a set of indexes associated with the signals on which the change of the relaxation status occurs. For example, on which RLM/BFD-RS(s) the relaxation state is changed in case multiple RLM/BFD-RS is configured.

In some example embodiments, the cause may comprise that the signal measurement is relaxed while the report is transmitted. In other words, the first device 110 may be allowed to report its relaxation status indicating that the first device 110 is relaxing although such reporting will cause the first device 110 to enter “no DRX is used” where the UE is not allowed to relax.

In some example embodiments, the cause may comprise that the relaxation criterion has been met and the signal measurement is to be relaxed during DRX (i.e., when DRX is used). In other words, the first device 110 may report that when the first device 110 has met the relaxation criterion and that the first device 110 may relax when the first device 110 enters to “DRX is used”. For example, the first device 110 may determine, during non-DRX, that the relaxation criterion is met. When DRX starts, the first device 110 may perform relaxation of the signal measurement. As another example, the first device 110 may determine, during non-DRX, that the relaxation criterion is not met. When DRX starts, the first device 110 may perform non-relaxation of the signal measurement.

In some example embodiments, the cause may comprise that the signal measurement is non-relaxed while the report is transmitted and the signal measurement is relaxed after the transmission of the report. In other words, the first device 110 may be allowed to report its relaxation status indicating that the first device 110 is relaxing although the first device 110 is not relaxing in case DRX is not used.

It is to be understood that the cause may comprise any other suitable information or combination of information. It is also to be understood that the report may comprise any other suitable contents. The present disclosure does not limit these aspects.

For illustration, some example embodiments will be described in connection with FIGS. 4A and 4B. FIG. 4A illustrates a diagram 400A illustrating an example reporting regarding a change of a relaxation status of signal measurement according to some embodiments of the present disclosure. In this example, a relaxation criterion remains met during no DRX. It is assumed that a DRX cycle is 80 ms.

As shown in FIG. 4A, at a timing t1, the first device 110 detects that a relaxation criterion is met and starts relaxation. However, at the timing t1, the first device 110 does not send #1 relaxation reporting indicating the start of relaxation because DRX is in use. At a timing t2, an on-duration for DRX starts. Then at the timing t2, the first device 110 sends the #1 relaxation reporting indicating the start of relaxation.

Relaxed measurement is performed when DRX is used. At a timing t3, an inactivity timer starts due to e.g. data transmission. Then DRX is not used but the first device 110 does not send #2 relaxation reporting indicating the reverting to non-relaxed measurement. Non-relaxed measurement is performed when DRX is not used. When the inactivity timer expires, the relaxation criterion is still met, and the first device 110 may start measurement relaxation again. However, the first device 110 does not again send #3 relaxation reporting indicating the start of relaxation as the change of relaxation status is trigger only due to a change from non-DRX to DRX.

FIG. 4B illustrates a diagram 400B illustrating an example reporting regarding a change of a relaxation status of signal measurement according to some embodiments of the present disclosure. In this example, a relaxation criterion becomes not met during non-DRX. It is assumed that a DRX cycle is 80 ms.

As shown in FIG. 4B, at a timing t4, the first device 110 detects that a relaxation criterion is met and starts relaxation. However, at the timing t4, the first device 110 does not send #1 relaxation reporting indicating the start of relaxation because DRX is in use. At a timing t5, an on-duration for DRX starts. Then at the timing t5, the first device 110 sends the #1 relaxation reporting indicating the start of relaxation.

Relaxed measurement is performed when DRX is used. At a timing t6, an inactivity timer starts due to e.g. data transmission. Then DRX is not used but the first device 110 does not send #2 relaxation reporting indicating the reverting to non-relaxed measurement. Non-relaxed measurement is performed when DRX is not used.

At a timing t7, the first device 110 may detect that a relaxation criterion becomes not met. When the inactivity timer expires, the first device 110 may enter “DRX is used”, and continue to perform non-relaxed measurement. The first device 110 may not send #3 relaxation reporting indicating the start of non-relaxation when the inactivity timer expiries. At a timing t8, an on-duration for DRX starts. At this moment, the first device 110 sends the #3 relaxation reporting indicating the change from relaxation to non-relaxation.

So far, the solution for relaxation status reporting according to embodiments of the present disclosure is described. It should be noted that actions shown in FIG. 3 are not always necessary for implementing embodiments of the present disclosure, and more or less actions may be adapted as needed. With the process in FIG. 3, a report regarding a change of a relaxation status of signal measurement may be sent properly and unnecessary signaling overhead and additional power consumption may be avoided.

### Example Implementation of Methods

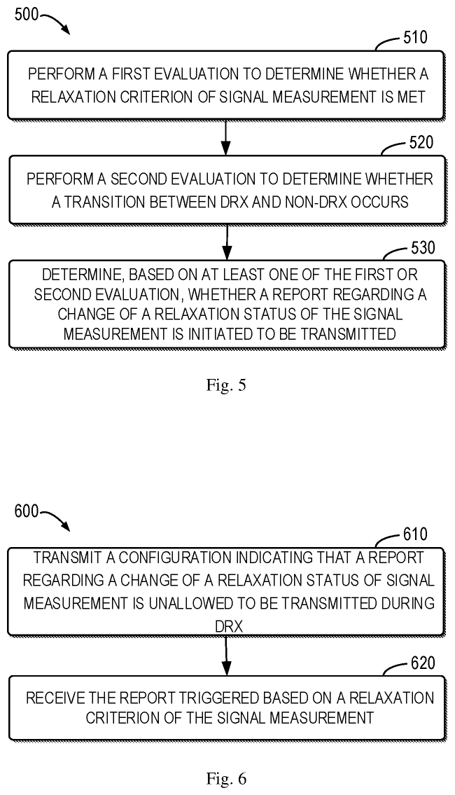

Corresponding to the process described in FIG. 3, embodiments of the present disclosure provide methods of communication implemented at a first device and at a second device. These methods will be described below with reference to FIGS. 5 to 6.

FIG. 5 illustrates a flowchart of a method 500 of communication implemented at a first device according to example embodiments of the present disclosure. The method 500 can be implemented at the first device 110 shown in FIG. 1. For the purpose of discussion, the method 500 will be described with reference to FIG. 1. It is to be understood that method 500 may further include additional blocks not shown and/or omit some shown blocks, and the scope of the present disclosure is not limited in this regard.

As shown in FIG. 5, at block 510, the first device 110 performs a first evaluation to determine whether a relaxation criterion of signal measurement is met. In some embodiments, the first device 110 may perform the first evaluation by evaluating at least one of the following: radio link quality; a mobility state; or serving cell quality. It is to be understood that any other suitable ways are also feasible.

At block 520, the first device 110 performs a second evaluation to determine whether a transition between DRX and non-DRX occurs. In some embodiments, the first device 110 may determine that the first device 110 is in non-DRX in response to DRX being not configured. In some embodiments, the first device 110 may determine that the first device 110 is in non-DRX in response to DRX being configured and at least one of the following: an inactivity timer for DRX being running; a retransmission timer for DRX for downlink being running; a retransmission timer for DRX for uplink being running; a contention resolution timer for RA being running; a SR transmitted on a PUCCH being pending; or a PDCCH transmission being unreceived after successful reception of a RAR for a preamble not selected by a MAC entity, the PDCCH transmission indicating a new transmission addressed to an identity of the MAC entity.

At block 530, the first device 110 determines, based on at least one of the first evaluation or the second evaluation, whether a report regarding a change of a relaxation status of the signal measurement is initiated to be transmitted to the second device 120.

In some embodiments, if the relaxation status is changed only due to the transition between DRX and non-DRX, the first device 110 may determine that the report is not initiated to be transmitted to the second device 120. In some embodiments, the first device 110 may further keep the performing of the first evaluation.

In some embodiments, if the relaxation status is changed based on the relaxation criterion, the first device 110 may determine that the report is initiated to be transmitted to the second device 120.

In some embodiments, the first device 110 may delay the transmission of the report until an on-duration starts in response to at least one of the following: the report being triggered during DRX; the report indicating a change of a relaxation status from relaxation of signal measurement to non-relaxation of signal measurement; or a configuration being received from the second device 120, the configuration indicating that the report is unallowed to be transmitted during DRX.

In some embodiments, the report may comprise at least one of the following: a period of time for which the change of the relaxation status of the signal measurement has been performed; or a cause of the change of the relaxation status of the signal measurement. It is to be understood that any other suitable information may also be comprised in the report.

In some embodiments, the cause may comprise at least one of the following: a change of a low mobility state; a change of serving cell quality; a set of signals on which the change of the relaxation status occurs; the signal measurement is relaxed while the report is transmitted; the relaxation criterion has been met and the signal measurement is to be relaxed during DRX; or the signal measurement is non-relaxed while the report is transmitted and the signal measurement is relaxed after the transmission of the report. It is to be understood that any other suitable information is also feasible.

In some embodiments, the first device 110 may determine, during non-DRX, that the relaxation criterion is met. In response to starting DRX, the first device 110 may perform relaxation of the signal measurement. In some embodiments, the first device 110 may determine, during non-DRX, that the relaxation criterion is not met. In response to starting DRX, the first device 110 may perform non-relaxation of the signal measurement.

With the method 500, a report regarding a change of a relaxation status of signal measurement may be sent properly and unnecessary signaling overhead and additional power consumption may be avoided.

FIG. 6 illustrates a flowchart of a method 600 of communication implemented at a second device according to example embodiments of the present disclosure. The method 600 can be implemented at the second device 120 shown in FIG. 1. For the purpose of discussion, the method 600 will be described with reference to FIG. 1. It is to be understood that method 600 may further include additional blocks not shown and/or omit some shown blocks, and the scope of the present disclosure is not limited in this regard.

As shown in FIG. 6, at block 610, the second device 120 transmits, to the first device 110, a configuration indicating that a report regarding a change of a relaxation status of signal measurement is unallowed to be transmitted during DRX.

At block 620, the second device 120 receives, from the first device 110, the report triggered based on a relaxation criterion of the signal measurement.

In some embodiments, the report may comprise at least one of the following: a period of time for which the change of the relaxation status of the signal measurement has been performed; or a cause of the change of the relaxation status of the signal measurement. It is to be understood that any other suitable information is also feasible.

In some embodiments, the cause may comprise at least one of the following: a change of a low mobility state; a change of serving cell quality; a set of signals on which the change of the relaxation status occurs; the signal measurement is relaxed while the report is transmitted; the relaxation criterion has been met and the signal measurement is to be relaxed during DRX; or the signal measurement is non-relaxed while the report is transmitted and the signal measurement is relaxed after the transmission of the report. It is to be understood that any other suitable information is also feasible.

With the method 600, a report regarding a change of a relaxation status of signal measurement may be sent properly based on a network configuration and unnecessary signaling overhead and additional power consumption may be avoided. In addition, at least network may avoid the flood of UE reports solely aiming at informing the network of entering or leaving relaxed measurements.

### Example Implementation of Apparatuses and Devices

In some example embodiments, an apparatus capable of performing any of the method 500 (for example, the first device 110) may comprise means for performing the respective steps of the method 500. The means may be implemented in any suitable form. For example, the means may be implemented in a circuitry or software module.

In some example embodiments, the apparatus comprises means for performing, at a first device, a first evaluation to determine whether a relaxation criterion of signal measurement is met; means for performing a second evaluation to determine whether a transition between discontinuous reception and non-discontinuous reception occurs; and means for determining, based on at least one of the first evaluation or the second evaluation, whether a report regarding a change of a relaxation status of the signal measurement is initiated to be transmitted to a second device.

In some embodiments, the means for performing the first evaluation may comprise means for evaluating at least one of the following: radio link quality; a mobility state; or serving cell quality.

In some example embodiments, the means for determining may comprise: means for, in accordance with a determination that the relaxation status is changed only due to the transition between discontinuous reception and non-discontinuous reception, determining that the report is not initiated to be transmitted to the second device. In some example embodiments, the apparatus may further comprise means for keeping the performing of the first evaluation.

In some example embodiments, the means for performing the second evaluation comprises means for determining that the first device is in the non-discontinuous reception in response to the discontinuous reception being not configured. In some example embodiments, the means for performing the second evaluation comprises means for determining that the first device is in the non-discontinuous reception in response to the discontinuous reception being configured and at least one of the following: an inactivity timer for the discontinuous reception being running; a retransmission timer for the discontinuous reception for downlink being running; a retransmission timer for the discontinuous reception for uplink being running; a contention resolution timer for random access being running; a scheduling request transmitted on a physical uplink control channel being pending; or a physical downlink control channel transmission being unreceived after successful reception of a random access response for a preamble not selected by a medium access control entity, the physical downlink control channel transmission indicating a new transmission addressed to an identity of the medium access control entity.

In some example embodiments, the means for determining comprises: means for, in accordance with a determination that the relaxation status is changed based on the relaxation criterion, determining that the report is initiated to be transmitted to the second device. In some example embodiments, the apparatus may further comprise means for delaying the transmission of the report until an on-duration starts in response to at least one of the following: the report being triggered during discontinuous reception; the report indicating a change of a relaxation status from relaxation of signal measurement to non-relaxation of signal measurement; or a configuration being received from the second device, the configuration indicating that the report is unallowed to be transmitted during discontinuous reception.

In some example embodiments, the report comprises at least one of the following: a period of time for which the change of the relaxation status of the signal measurement has been performed; or a cause of the change of the relaxation status of the signal measurement.

In some example embodiments, the cause comprises at least one of the following: a change of a low mobility state; a change of serving cell quality; a set of signals on which the change of the relaxation status occurs; the signal measurement is relaxed while the report is transmitted; the relaxation criterion has been met and the signal measurement is to be relaxed during the discontinuous reception; or the signal measurement is non-relaxed while the report is transmitted and the signal measurement is relaxed after the transmission of the report.

In some example embodiments, an apparatus capable of performing any of the method 600 (for example, the second device 120) may comprise means for performing the respective steps of the method 600. The means may be implemented in any suitable form. For example, the means may be implemented in a circuitry or software module.

In some example embodiments, the apparatus comprises: means for transmitting, at a second device and to a first device, a configuration indicating that a report regarding a change of a relaxation status of signal measurement is unallowed to be transmitted during discontinuous reception; and means for receiving, from the first device, the report triggered based on a relaxation criterion of the signal measurement.

In some example embodiments, the report comprises at least one of the following: a period of time for which the change of the relaxation status of the signal measurement has been performed; or a cause of the change of the relaxation status of the signal measurement.

In some example embodiments, the cause comprises at least one of the following: a change of a low mobility state; a change of serving cell quality; a set of signals on which the change of the relaxation status occurs; the signal measurement is relaxed while the report is transmitted; the relaxation criterion has been met and the signal measurement is to be relaxed during the discontinuous reception; or the signal measurement is non-relaxed while the report is transmitted and the signal measurement is relaxed after the transmission of the report.

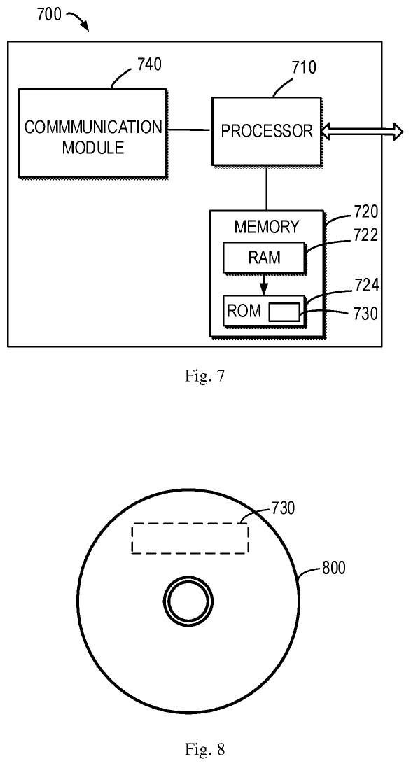

FIG. 7 is a simplified block diagram of a device 700 that is suitable for implementing embodiments of the present disclosure. The device 700 may be provided to implement the first device or second device, for example first device 110 or the second device 120 as shown in FIG. 1. As shown, the device 700 includes one or more processors 710, one or more memories 720 coupled to the processor 710, and one or more communication modules 740 (such as, transmitters and/or receivers) coupled to the processor 710.

The communication module 740 is for bidirectional communications. The communication module 740 has at least one antenna to facilitate communication. The communication interface may represent any interface that is necessary for communication with other network elements.

The processor 710 may be of any type suitable to the local technical network and may include one or more of the following: general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a Read Only Memory (ROM) 724, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 722 and other volatile memories that will not last in the power-down duration.

A computer program 730 includes computer executable instructions that are executed by the associated processor 710. The program 730 may be stored in the ROM 724. The processor 710 may perform any suitable actions and processing by loading the program 730 into the RAM 722.

The embodiments of the present disclosure may be implemented by means of the program 730 so that the device 700 may perform a process of the disclosure as discussed with reference to FIG. 3. The embodiments of the present disclosure may also be implemented by hardware or by a combination of software and hardware.

In some example embodiments, the program 730 may be tangibly contained in a computer readable medium which may be included in the device 700 (such as in the memory 720) or other storage devices that are accessible by the device 700. The device 700 may load the program 730 from the computer readable medium to the RAM 722 for execution. The computer readable medium may include any types of tangible non-volatile storage, such as ROM, EPROM, a flash memory, a hard disk, CD, DVD, and the like. FIG. 8 shows an example of the computer readable medium 800 in form of CD or DVD. The computer readable medium has the program 730 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the methods 500 and 600 as described above with reference to FIGS. 5 and 6. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A first device, comprising:
at least one processor; and
at least one memory storing instructions that, when executed by the at least one processor, cause the first device at least to:
perform a first evaluation to determine whether a relaxation criterion of signal measurement is met;
perform a second evaluation to determine whether a transition between discontinuous reception and non-discontinuous reception occurs; and
determine, based on at least one of the first evaluation or the second evaluation, whether a report regarding a change of a relaxation status of the signal measurement is initiated to be transmitted to a second device.

2. The first device of claim 1, wherein the first device is caused to determine whether the report is initiated to be transmitted by:
in accordance with a determination that the relaxation status is changed only due to the transition between discontinuous reception and non-discontinuous reception, determining that the report is not initiated to be transmitted to the second device.

3. The first device of claim 2, wherein the first device is further caused to:
keep the performing of the first evaluation.

4. The first device of claim 1, wherein the first device is caused to perform the second evaluation by:
determining that the first device is in the non-discontinuous reception in response to one of the following:
the discontinuous reception being not configured; or
the discontinuous reception being configured and at least one of the following:
an inactivity timer for the discontinuous reception being running;
a retransmission timer for the discontinuous reception for downlink being running;
a retransmission timer for the discontinuous reception for uplink being running;
a contention resolution timer for random access being running;
a scheduling request transmitted on a physical uplink control channel being pending; or
a physical downlink control channel transmission being unreceived after successful reception of a random access response for a preamble not selected by a medium access control entity, the physical downlink control channel transmission indicating a new transmission addressed to an identity of the medium access control entity.

5. The first device of claim 1, wherein the first device is caused to determine whether the report is initiated to be transmitted by:
in accordance with a determination that the relaxation status is changed based on the relaxation criterion, determining that the report is initiated to be transmitted to the second device.

6. The first device of claim 5, wherein the first device is further caused to:
delaying the transmission of the report until an on-duration or an inactivity timer starts in response to at least one of the following:
the report being triggered during discontinuous reception;
the report indicating a change of a relaxation status from relaxation of signal measurement to non-relaxation of signal measurement; or
a configuration being received from the second device, the configuration indicating that the report is unallowed to be transmitted during discontinuous reception.

7. The first device of claim 1, wherein the report comprises at least one of the following:
a period of time for which the change of the relaxation status of the signal measurement has been performed; or
a cause of the change of the relaxation status of the signal measurement.

8. The first device of claim 7, wherein the cause comprises at least one of the following:
a change of a low mobility state;
a change of serving cell quality;
a set of signals on which the change of the relaxation status occurs;
the signal measurement is relaxed while the report is transmitted;
the relaxation criterion has been met and the signal measurement is to be relaxed during the discontinuous reception; or
the signal measurement is non-relaxed while the report is transmitted and the signal measurement is relaxed after the transmission of the report.

9. The first device of claim 1, wherein the first device is caused to perform the first evaluation by:
evaluating at least one of the following:
radio link quality;
a mobility state; or
serving cell quality.

10. The first device of claim 1, wherein the first device is further caused to:
determine, during the non-discontinuous reception, that the relaxation criterion is met or not met; and
in response to starting the discontinuous reception,
perform relaxation of the signal measurement if the relaxation criterion is met; or
perform non-relaxation of the signal measurement if the relaxation criterion is not met.

11. A second device, comprising:
at least one processor; and
at least one memory storing instructions that, when executed by the at least one processor, cause the second device at least to:
transmit, to a first device, a configuration indicating that a report regarding a change of a relaxation status of signal measurement is unallowed to be transmitted during discontinuous reception; and
receive, from the first device, the report triggered based on a relaxation criterion of the signal measurement.

12. The second device of claim 11, wherein the report comprises at least one of the following:
a period of time for which the change of the relaxation status of the signal measurement has been performed; or
a cause of the change of the relaxation status of the signal measurement.

13. The second device of claim 12, wherein the cause comprises at least one of the following:
a change of a low mobility state;
a change of serving cell quality;
a set of signals on which the change of the relaxation status occurs;
the signal measurement is relaxed while the report is transmitted;
the relaxation criterion has been met and the signal measurement is to be relaxed during the discontinuous reception; or
the signal measurement is non-relaxed while the report is transmitted and the signal measurement is relaxed after the transmission of the report.

14. A method of communication, comprising:
performing, at a first device, a first evaluation to determine whether a relaxation criterion of signal measurement is met;
performing a second evaluation to determine whether a transition between discontinuous reception and non-discontinuous reception occurs; and
determining, based on at least one of the first evaluation or the second evaluation, whether a report regarding a change of a relaxation status of the signal measurement is initiated to be transmitted to a second device.

15. The method of claim 14, wherein determining whether the report is initiated to be transmitted comprises:
in accordance with a determination that the relaxation status is changed only due to the transition between discontinuous reception and non-discontinuous reception, determining that the report is not initiated to be transmitted to the second device.

16. The method of claim 15, further comprising:
keeping the performing of the first evaluation.

17. The method of claim 14, wherein performing the second evaluation comprises:
determining that the first device is in the non-discontinuous reception in response to one of the following:
the discontinuous reception being not configured; or
the discontinuous reception being configured and at least one of the following:
an inactivity timer for the discontinuous reception being running;
a retransmission timer for the discontinuous reception for downlink being running;
a retransmission timer for the discontinuous reception for uplink being running;
a contention resolution timer for random access being running;
a scheduling request transmitted on a physical uplink control channel being pending; or
a physical downlink control channel transmission being unreceived after successful reception of a random access response for a preamble not selected by a medium access control entity, the physical downlink control channel transmission indicating a new transmission addressed to an identity of the medium access control entity.

18. The method of claim 14, wherein determining whether the report is initiated to be transmitted comprises:
in accordance with a determination that the relaxation status is changed based on the relaxation criterion, determining that the report is initiated to be transmitted to the second device.

19. The method of claim 18, further comprising:
delaying the transmission of the report until an on-duration starts in response to at least one of the following:
the report being triggered during discontinuous reception;
the report indicating a change of a relaxation status from relaxation of signal measurement to non-relaxation of signal measurement; or
a configuration being received from the second device, the configuration indicating that the report is unallowed to be transmitted during discontinuous reception.

20. The method of claim 14, wherein the report comprises at least one of the following:
a period of time for which the change of the relaxation status of the signal measurement has been performed; or
a cause of the change of the relaxation status of the signal measurement.

21.-25. (canceled)
